(19) United States
(12) Patent Application Publication
(10) Pub. No.: US 2002/0013115 A1
(43) Pub. Date: Jan. 31, 2002

(54) Process for producing flat panel display containing getter material

(75) Inventor: Chiharu Maeda, Tokyo (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: SAES GETTERS JAPAN CO., Ltd.

(21) Appl. No.: 09/907,147

(22) Filed: Jul. 16, 2001

Related U.S. Application Data
(63) Continuation of application No. PCT/IB00/00050, filed on Jan. 17, 2000.

(30) Foreign Application Priority Data
Jan. 22, 1999 (JP) 11-14330

(51) Int. Cl. H01J 9/26

(52) U.S. Cl. 445/25; 445/40; 445/41

(57) ABSTRACT

In a flat panel display containing a getter material, the getter material is activated during the sealing step, and is partially consumed, if the getter activation temperature is lower than the sealing temperature. On the other hand, a very small part of the getter material is activated if the getter activation temperature is higher than the sealing temperature. The problems are solved by a process comprising the steps of:

providing front and rear glass plates of a flat panel display, both supporting the functional elements which are required for the final display;

disposing a flat getter device on one of the glass plates at the position determined in the final display;

sealingly joining the two glass plates by means of a sealing material which, upon solidification at a temperature T₁, gives rise to a solid having a melting temperature higher than T₁;

baking the thus-produced flat panel display at a temperature higher than T₁ while evacuating its inner space through a glass tube left in one of the two glass plates;

activating the getter material at a temperature higher than T₁; and

closing the inner space of the display by “tipping-off” the glass tube.

### CROSS-REFERENCE TO RELATED APPLICATION

This application is a continuation of International Application No. PCT/IB00/00050, filed Jan. 17, 2000, the disclosure of which is incorporated herein by reference. The International Application was published in the English language on Jul. 27, 2000, under Publication No. WO 00/44024.

### BACKGROUND OF THE INVENTION

The present invention relates to a process for the production of flat panel displays containing a getter material.

Flat panel displays (FPD hereinafter) are intensively studied in view of their use in a number of applications. One of the main goals of the industry is to replace bulky CRTs with small display devices. Among the most promising kinds of FPD there are Plasma Display Panels and Field Emitting Displays, also referred to as PDP and FED, respectively. Both of these displays are composed of a front and a rear glass plate, joined at their peripheral edge. The two glass plates are spaced apart about 0.1-0.2 mm, thus creating an inner space that contains active or functional components of the display (phosphors; arrays of feedthroughs and electron emitting microtips in the case of FED; a wall structure defining cells in the case of PDP).

For better performance over their expected life span, both FED and PDP need the presence of a getter device. In FED, the getter has the function of keeping the pressure inside the evacuated space of the display at about 10-3 mbar or less, thus avoiding electrons being absorbed or scattered along their path from the emitting tip to the phosphor. In PDP, the getter assures constant chemical composition of the mixture of noble gasses filled in the display, and thereby a constant operating property. Possible shapes and dispositions of the getter device inside FED are described, for instance, in Kokai (Japanese Unexamined Patent Publication) JP-A-7-29520 and JP-A-7-29521, in European Patent Publication EP-A-780872, in International Patent Publications WO 95/23425 and WO 96/01492, and in U.S. Pat. No. 5,639,356. Getters in PDP are described in Kokai JP-A-10-188829, JP-A-10-69860 and JP-A10-296596.

Among getter materials, zirconium- or titanium-based alloys are the most useful, due to their wide range of gas absorbing property. In particular, getter devices comprising powder of Zr—V—Fe alloy, alone or in combination with Zr or Ti powder, are preferred. These getter materials need, at the beginning of their operating life, a thermally activating treatment, that causes diffusing oxides, nitrides and carbides (present on the grain surface of the getter powder after being produced) toward the bulk of the same grain, thus liberating the free surface to be ready for gas sorption, depending on the actual chemical composition of the getter material. The thermally activating treatment may be carried out at a temperature between about 300 and 500° C., for 10 to 60 minutes.

The production of FPD comprises a step of joining the two glass plates together at their periphery, normally by means of glass paste which is called frit glass and which melts at a relatively low-temperature, and a step of frit sealing. During the frit sealing, the frit glass is heated to a temperature T₁ sufficient to cause the frit to melt in air. When the temperature is lowered, the frit glass solidifies, sealing the glass plates and thereby creating an inner space in the FPD.

The frit sealing step is normally followed by a step called normally as “baking,” by which the inner space is evacuated while the display is heated. Vacuum is needed in FED, while the evacuation of PDP is a preliminary step to back filling with the desired atmosphere. Heating the display during evacuation helps the inner components (particularly the phosphors) to release most of the adsorbed gasses, that would otherwise be outgassed in the inner space of the display during its life, thus leading to degradation of the vacuum degree (in FED) or of the gas purity (in PDP) in said space.

There are two possible ways of introducing a getter device inside (or in connection with) the inner space of FPDs.

According to a first possible option, the getter device is placed in a glass tube which is connected to the rear glass plate and is used for evacuating the inner space during baking. After evacuation, the tube is sealed by squeezing it with a suitable heating tool at a certain distance from the rear plate. This step is called “tip-off.” The getter device, generally in a form of a pill of compressed getter powder, is located in the tail portion at the remaining part of the glass tube. This first option has defects in that the tail increases the overall thickness of the display, and that the getter is in contact with the inner space only through a hole, generally a few mm² in area, with the result that the removal of the impurities present in the inner space at a location far from the getter position may take a long time.

Preferred by FPD manufacturers is the use of flat getter devices placed directly inside the inner space. The getter devices are generally made of getter powder laid on a metallic substrate and are positioned in a peripheral area of the display. These devices obviously need to have been placed in the inner space of the display prior to the frit sealing step. A problem however arises because, if the temperature for activating the getter material is lower than the temperature T₁ for frit sealing, the getter material becomes activated during the sealing step, in a surrounding atmosphere comprising air and vapor given off by the frit glass; the getter device thus starts absorbing gas, and its sorption capacity is at least partially spent. If, on the other hand, the temperature required for getter activation is higher than T₁, the getter material can only be partially activated. The problem may be partly overcome by means of the so-called frittable getters. The material is not too heavily spent during frit sealing and maintains, even after the frit sealing step, absorption capacity sufficient for their operation during the FPD life. One such material is produced and sold by SAES Getters S.p.A., Lainate, Italy, under the trademark St 122, which is a mixture of powders of a Zr—V—Fe alloy and titanium.

However, some exhaustion of the getter material property still occurs, causing the getter material inside the FPD not to exhibit, during its operating life, the best possible sorption capability. In addition, the range of suitable getter materials is limited to only a few out of a wide variety of possibilities.

### BRIEF SUMMARY OF THE INVENTION

Therefore, the object of the present invention is to provide a process for the production of flat panel displays containing a getter material that does not suffer from the drawbacks of the prior art.

This object is achieved according to the present invention by a process for the production of a flat panel display containing a getter material, comprising the steps of:

providing front and rear glass plates of a flat panel display, both supporting functional elements which are required for the final display;

disposing a flat getter device on one of the glass plates at the position determined in the final display;

sealingly joining the two glass plates by means of a sealing material which, upon solidification at a temperature T₁, gives rise to a solid having a melting temperature higher than T₁;

baking the thus-produced flat panel display at a temperature higher than T₁ while evacuating its inner space through a glass tube left in one of the two glass plates;

activating the getter material at a temperature higher than T₁; and

closing the inner space of the display by “tipping-off” the glass tube.

The baking step and the getter activation step may be performed in a single step.

### DETAILED DESCRIPTION OF THE INVENTION

It is important for carrying out the process of the invention to use a sealing material that after undergoing solidification at a temperature T₁ can stand thermal treatments at temperatures higher than T₁; temperature T₁ is preferably as low as possible, and the most desirable situation is when T₁ is equal to or about room temperature. Suitable materials are, for instance, polyimides, silicone rubbers, and a kind of frit glass which undergoes crystallization after first melting such that, when re-solidified, it becomes resistant to a temperature higher than that of the first melting. The frit glass is one of the crystallized glasses purposely crystallized using the crystallization phenomenon, which is generally considered to be less desirable, to improve mechanical and heat-resistant properties. The frit glass useful for the invention is referred to in the following as “crystalline frit glass.” Another material, preferred for use according to the invention, is a sealing paste recently developed by and available from the company Tosei Electrobeam Ltd. of Tokyo, Japan; this material is currently under evaluation in laboratories and it is provisionally referred to in the field with the name “i-seal.”

It has been known from a number of patent publications and articles to provide front and rear glass plates constituting the FPD, functional elements and devices. Thus, the provision itself is not the object of the present invention.

The second step of the process of the invention is to position a flat getter device on one of the two glass plates. The getter device of the invention is preferably a strip of getter material powder disposed along one or more edges of the display, in the area free of active components (phosphors and microtips in the case of FED; cells in the case of PDP, etc.) and close to the sealing area. The getter material powder preferably has a grain size of 100 μm or less, and more preferably between about 20 and 80 μm.

In order to maximize the amount, the getter material preferably has a form of a rectangular strip with a length of that of the edge on which it is placed, and a width of about 2 to 5 millimeters, depending on the dimension of the area free of active components. The getter material strip may be placed along one of the edges of the display, but it can be placed along more, or even all, of the edges.

The getter material could be placed directly onto the glass plate, in the form of a rectangular deposit. However, it is easier to produce the getter device separately, and to assemble the display and of the getter. Preferably, the getter device comprises a metallic support of generally about 20 to 100 μm thick. Metals that can be employed for the support or substrate include steel, titanium, nickel-plated iron, constantan, a nickel/chromium alloy and a nickel/iron alloy. The getter material can be deposited onto the support by a method of cold-rolling, electrophoresis or spraying. A screen-printing method as described in International Publication WO 98/03987 is preferred.

One preferred getter material for the invention is one of those produced and sold by SAES Getters SpA at Lainate, Italy, under the trademark St 121 or St 122, but the material is not limited thereto. St 121 is a mixture of 70% by weight of titanium and 30% by weight of a Zr 84%-Al 16% alloy produced and sold by SAES Getters under the name St 101. St 122 is a mixture of 70% by weight of titanium and 30% by weight of a Zr 70%-V 24.6%-Fe 5.4% alloy produced and sold by SAES Getters under the name St 707.

The next step of the process of the invention is to sealingly join the two glass plates which constitute the display. According to the invention, this step is realized by the use of a material selected among polyimides, silicone rubbers, the “i-seal” compound produced and sold by Tosei Electrobeam Ltd. or by a “crystalline frit glass” as defined above. Polyimides, silicone rubbers and the “i-seal” material have the feature of solidifying at room temperature (that is, T₁=room temperature), after which they are capable of standing thermal treatments at temperatures as high as 400° C. An example of frit glass useful for the invention is that sold as ASF 1307 from Asahi Glass K. K. This glass can be sealed at about 440° C. (T₁ in this case) and can stand a temperature as high as 500 ° C., after being solidified.

The use of the above indicated sealing materials allows adoption of a condition in which the sealing temperature and the baking temperature are reversed in the process for producing the FPD. According to known processes, the frit sealing temperature T₁ is the upper limit of the temperature under which the subsequent FPD step for the production can be carried out. The use of the above indicated material in the process of the invention removes this constraint, allowing carrying out the baking step and the getter activation step at a temperature higher than T₁. The upper process temperature limit in these cases is about 400° C. for polyimides, silicone rubbers and the “i-seal” material, and anyway not higher than 550° C., because the front and rear glass plates of the display will not be safe at a temperature above 550° C.

The baking step is performed similarly to that of the known processes, with the main difference that, according to invention, the baking temperature is higher than T₁. This allows better outgassing of these materials constituting the display, contributing to the fact that the inner space of the display will be clean during its life.

The getter activation step is also carried out at a temperature higher than T₁. According to the process of the invention, activating the getter is avoided during sealing in an air environment. Rather, the activation occurs in a low-pressure environment, so that the sorption capacity of the getter device for the FPD life is near to its theoretical value.

The last step is to tip-off the tube temporarily left in one of the glass plates (normally the rear glass plate). By carrying out this step, the inner space of the display is isolated from the external space. The tip-off step is not described in detail because the step is normally employed in the field concerned.

In a preferred embodiment of the process of the invention, the step of getter activation is performed during baking, thus avoiding the need of two separate steps. Moreover, if the getter material becomes activated during the baking step, it acts as a supplemental “insitu” pump during the process, whereby shortening of the evacuation time and improvement of the vacuum level reached during baking are realized.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A process for producing a flat panel display containing a getter material, comprising the steps of:
providing front and rear glass plates of a flat panel display, both supporting functional elements which are required for a final display;
disposing a flat getter device on one of the glass plates at a position determined in the final display;
sealingly joining the two glass plates by means of selaing material which, upon solidification at a temperature T₁, gives rise to a solid have a melting temperature hight than T₁;
baking the thus-produced flat panel display at a temperature higher than T₁ while evacuating its inner space through a glass tube left in one of the two glass plates;
activating the getter material at a temperature higher than T₁; and
closing the inner space of the display by “tipping-off” the glass tube.

2. A process according to claim 1, wherein the baking step and the getter activation step are performed in a single step.
